(19) United States
(12) Patent Application Publication
(10) Pub. No.: US 2003/0076603 A1
(43) Pub. Date: Apr. 24, 2003

(54) Method and apparatus for easy attachment and alignment of 3D stereoscopic enabling devices

(76) Inventors: Carl Tung, Mohegan Lake, NY (US); Adam Divelbiss, Wappingers Falls, NY (US); David Swift, Cortlandt Manor, NY (US)

Correspondence Address: Gerow D. Brill, Reveo, Inc., 85 Executive Boulevard, Elmsford, NY, 10523, US

(21) Appl. No.: 10/274,640

(22) Filed: Oct. 21, 2002

Related U.S. Application Data
(60) Provisional application No. 60/348,401, filed on Oct. 19, 2001.

(51) Int. Cl. G02B 7/02

(52) U.S. Cl. 359/819; 359/811; 359/818

(57) ABSTRACT

The present disclosure addresses the problem of attaching and adjusting 3D stereoscopic enabling devices by providing a means and apparatus to attach and align the SEDs in a simple straightforward manner. Several mounting options are available that fall into two main categories including spring-clip and screw-clip mounting systems. Any of the major stereoscopic enabling devices including but not limited to VRex Micropol, lenticular array, microlens array, parallax barrier, holographic array may be mounted to a flat panel display (using various display technologies including LCD, plasma, OLED, etc.) or notebook computer display using one of these two mounting system types. Once initial mounting of the stereoscopic enabling device has been achieved, a means for proper alignment for optimal 3D stereoscopic viewing is provided using an appropriate test image depending on the stereoscopic enabling device that is used.

### CROSS-REFERENCES

This application is related to provisional patent application No. 60/348,401 filed on Oct. 19, 2001 entitled Method and Apparatus for Easy Attachment and Alignment of 3D Stereoscopic Enabling Devices and is hereby incorporated by reference.

### FIELD OF INVENTION

The present invention is related to stereoscopic displays, in particular to the application and alignment of 3D stereoscopic enabling devices to flat panel displays such as LCD monitors and notebook computers.

### BACKGROUND OF THE INVENTION

The present invention addresses the problem of the application and alignment of 3D stereoscopic enabling devices to flat panel displays such as (but not limited to) LCD monitors and notebook computers. There are numerous ways to enable such devices for 3D stereoscopic viewing. However, to date, there has been no easy method or apparatus by which the average consumer would be able to attach and align a 3D stereoscopic enabling device SED (such as a VRex Micropol™, a lenticular optical device, or parallax barrier) to a home laptop or flat panel display. The present invention provides both an apparatus and means that greatly simplifies the use of 3D enabling devices on such displays. Most systems (VRex micropol, lenticular arrays, etc.) have been permanently mounted, making after market 3D kits for the vast majority of non-3D enabled product impossible to realize. To enable a flat panel display or notebook computer for 3D stereoscopic viewing required a stereoscopic enabling devise to be permanently mounted to the display.

There is a need for solving the problem of attaching and adjusting 3D stereoscopic enabling devices by providing a means and apparatus to attach and align the SEDs in a simple straightforward manner.

### SUMMARY OF THE INVENTION

The present is directed to the problem of attaching and adjusting 3D stereoscopic enabling devices by providing a means and apparatus to attach and align the SEDs in a simple straightforward manner. Several mounting options are available that fall into two main categories including spring-clip and screw-clip mounting systems. Any of the major stereoscopic enabling devices including but not limited to VRex Micropol, lenticular array, microlens array, parallax barrier, holographic array may be mounted to a flat panel display (using various display technologies including LCD, plasma, OLED, etc.) or notebook computer display using one of these two mounting system types.

Once initial mounting of the stereoscopic enabling device has been achieved, a means for proper alignment for optimal 3D stereoscopic viewing is provided using an appropriate test image depending on the stereoscopic enabling device that is used.

### BRIEF DESCRIPTION OF THE DRAWINGS

The following drawings along with the Detailed Description are descriptive of the various embodiments of the invention wherein:

FIG. 1 illustrates an overall attachment and alignment apparatus block diagram;

FIG. 2 illustrates an attachment and alignment process flow diagram;

FIG. 3 illustrates a first embodiment of a spring clip mounting apparatus with a removable grip for a laptop display (side view);

FIG. 4 illustrates a second embodiment of a spring clip mounting apparatus type 2 with removable grip for laptop display (side view);

FIG. 5 illustrates a third embodiment, a screw clip mounting apparatus with removable grip for flat panel display (side view);

FIG. 6 illustrates a Micropol 3D stereoscopic enabling device;

FIG. 7 illustrates a parallax barrier 3D stereoscopic enabling device;

FIG. 8 illustrates a lenticular 3D stereoscopic enabling device;

FIG. 9 illustrates a vertical adjustable clip; and

FIG. 10 illustrates a horizontal adjustable clip.

### DETAILED DESCRIPTION OF THE INVENTION

Overall Attachment and Alignment Apparatus Block Diagram

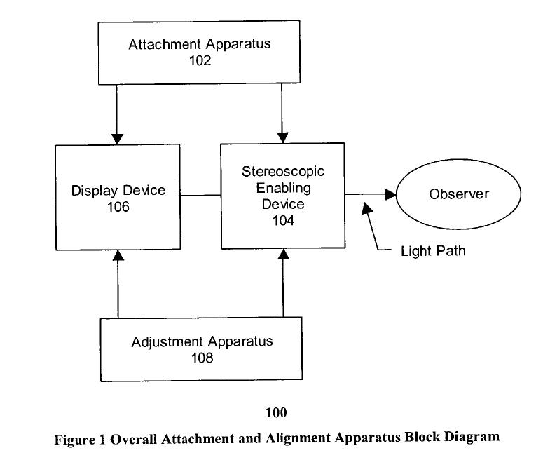

FIG. 1 illustrates the overall block diagram for the various embodiments of the present invention. The basic idea is to provide an apparatus that afford convenient attachment and alignment of a stereoscopic enabling element to a display device. The block diagram 100 illustrates an attachment apparatus 102 binding the 3D stereoscopic enabling device (SED) 104 to the display device 106. The purpose of the attachment apparatus is to hold the SED firmly in place while providing enough freedom of movement across the display device surface to allow proper alignment. The embodiments of the attachment apparatus may take one of two forms or a combination of both. These attachment forms include spring-clip based attachment devices and compression screw based clips. Proper alignment is achieved according to the alignment means outlined below. The drawing illustrates an alignment apparatus 108 that makes it easy for a user to align the SED with little prior experience.

Attachment and Alignment Process Flow Diagram

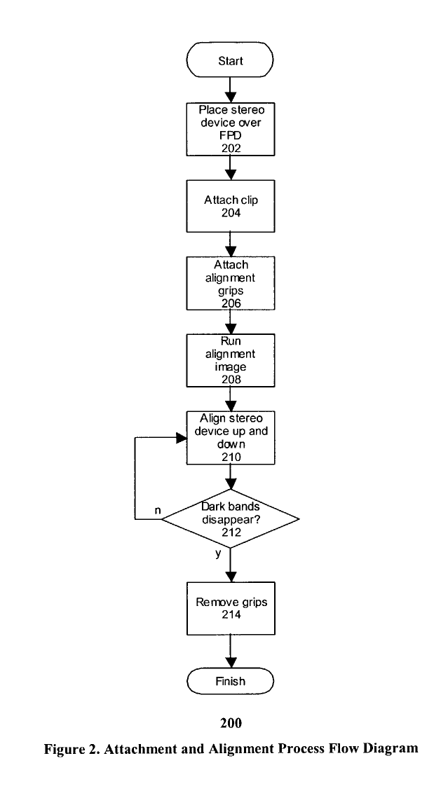

FIG. 2 illustrates a flow diagram 200 of the attachment and alignment process flow for the preferred embodiment. The first step involves placement of the SED over the display device 202 active area. It is important for many SED types (e.g., VRex micropol and lenticular) that the SED be placed in the proper orientation for 3D viewing. One of the various attachment clip devices 206 is used to secure the SED to the display device. Enough compression should be applied to keep the SED in place but allow the user to adjust the alignment later in the process. The third step is to attach the removable adjustment grips 206 if they are to be used. The alignment image 208 is presented for display on the display device. This image will aid in alignment of the SED by providing a left-perspective image for the left eye and a right-perspective image for the right eye (such a the left eye perspective image is a single black field and the right perspective image is a single white field, or other distinctive alignment image). Proper alignment is achieved when the left eye of the user sees only the left perspective image and the right eye of the user sees only the right perspective image. For example, the alignment will indicate proper adjustment has been reached when dark bands disappear in the viewed image. Next the adjustment apparatus is used to slide the SED over the surface of the display device to achieve proper alignment. Once alignment is achieved remove the adjustment grips 214 if necessary.

Spring Clip Mounting Apparatus with Removable Grip for Laptop Display (Side View)

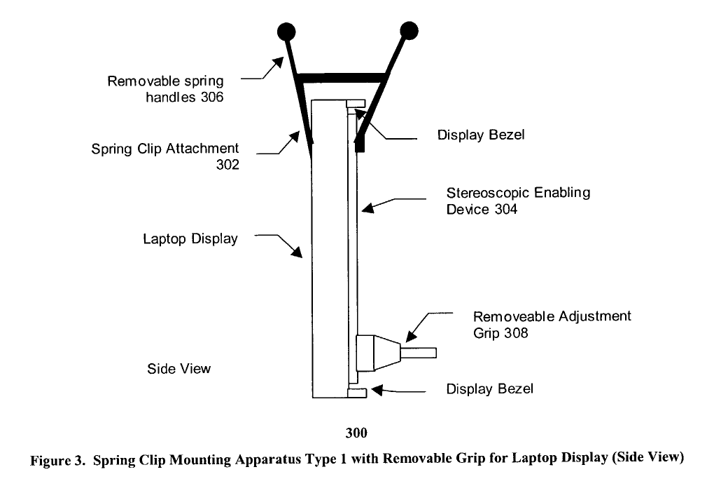

FIG. 3 illustrates a spring-clip based mounting apparatus 300 with removable spring handles. The spring clip 302 attaches the 3D stereoscopic enabling apparatus to the display device (in this case a Laptop Display) by providing sufficient compression for friction to prevent the SED from moving with respect to the display under normal usage. However, compression provided by the spring clip is sufficiently low to allow a user to slide the SED across the display surface for proper alignment. Another feature of this spring clip is that it extends from the backside of the display, over the top of the display and a cross the display bezel to the SED. Multiple clips may be used depending on the security required. Once the clip has been positioned to the desired location, the spring handles 306 may be removed for convenience.

FIG. 3 also illustrates the location of a removable adjustment grip 308. One or more removable adjustment grips may be attached to the SED to help the user during the alignment process. In a preferred embodiment these devices may of a suction cup and handle that allow the user to easily attach and remove them from the SED.

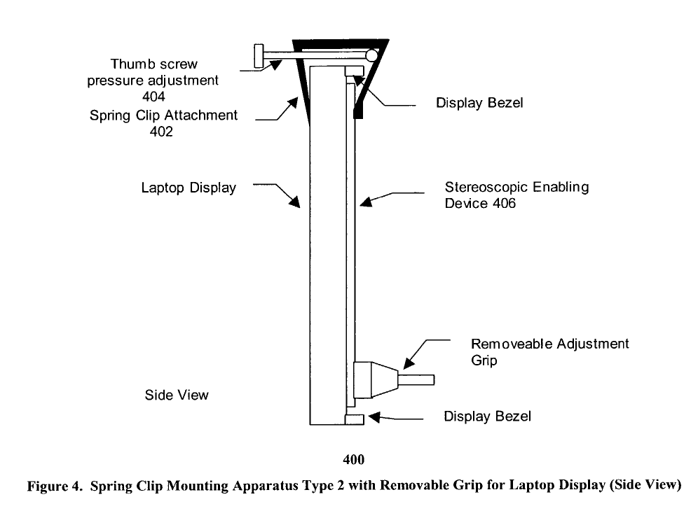

FIG. 4 illustrates a side view diagram of an alternative embodiment 400 of a spring-clip device 402 for attachment. In this case a thumbscrew 404 is used inside the spring-clip to adjust the compression of the clip. This adjustment capability allows greater freedom of control for the user in the alignment process and the more compact design is more convenient for practical use.

Screw Clip Mounting Apparatus with Removable Grip for Flat Panel Display (Side View)

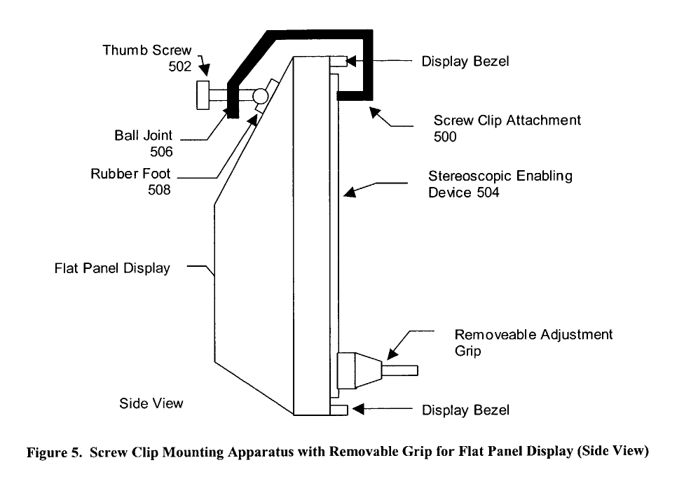

FIG. 5 illustrates an example of a compression-screw type attachment clip 500. In this case the clip holds the SED to the display device by compression induced by a thumbscrew 502 instead of by the spring action of the metal clip. This attachment type is useful for oddly shaped flat panel displays or displays that have a larger distance between the front and back of the display chassis. The thumbscrew 502 is placed opposite the front side of the clip to prevent an inadvertent sliding and side forces on the SED 504. A ball joint 506 on the thumbscrew insures that the applied force is perpendicular to the SED. The applied force from the ball joint may be applied via a rubber foot 508. As in the alternative spring clips case, the user may adjust the compression strength for easier alignment of the SED 506. Once proper alignment is accomplished, the thumbscrew may be tightened for more secure attachment.

Micropol 3D Stereoscopic Element

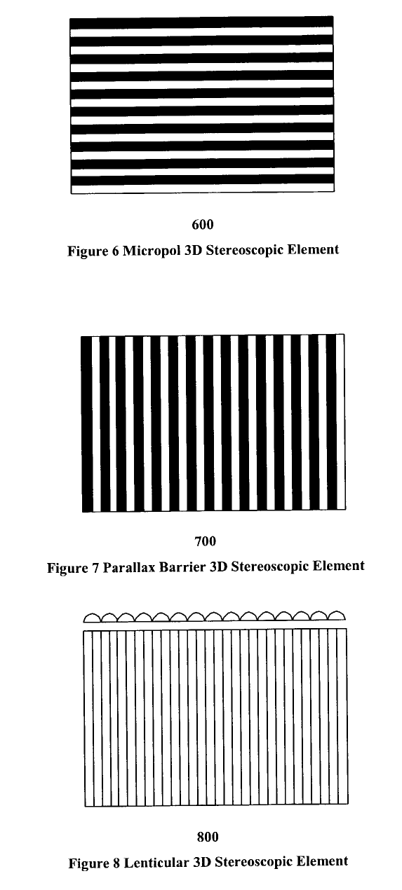

FIG. 6 illustrates the micropolarizer (Micropol) SED 600. The micropolarizer SED changes polarization of light on a line-by-line basis (or pixel-by-pixel) basis. The process of stereoscopic viewing requires two views of a scene (a left and right perspective) to be directed to the viewer's left and right eyes, respectively. A spatially multiplexed image (SMI) combines the left and right eye perspectives, alternating line by line (or pixel-by-pixel). The micropolarizer SED alternates the polarization structure of the display so that adjacent lines (or pixels) will have orthogonal (or opposite) polarization. When the viewer puts on polarizing glasses, one eye will see one set of lines (or pixels) and the other eye will see the other set of lines (or pixels). The human brain, through a process call stereopsis, processes the two images producing depth. The μPol can be placed on any kind of displays, including but not limited to LCDs, plasma, projection screens, notebook computers, etc.

Parallax Barrier 3D Stereoscopic Element

FIG. 7 illustrates the parallax barrier SED 700. The parallax barrier SED 702 consists of a fine, vertical slit plate of alternating clear and opaque stripes. The SED 702 is placed in front of a specially prepared image. The image consists of alternating right-eye and left-eye stripes corresponding to the left and right image perspectives. Each slit in the barrier acts as a window onto a stripe of the section of the image that lies behind it. Exactly which stripe of the image is visible depends on the horizontal angle from which the slit is viewed. At an appropriate position, the viewer will see the right view of the image through the slits with the right eye and the left view with the left eyes. The opaque barrier blocks the left image from the right eye and the right image from the left eye. Through stereopsis, the viewer will see a stereoscopic image.

Lenticular 3D Stereoscopic Element

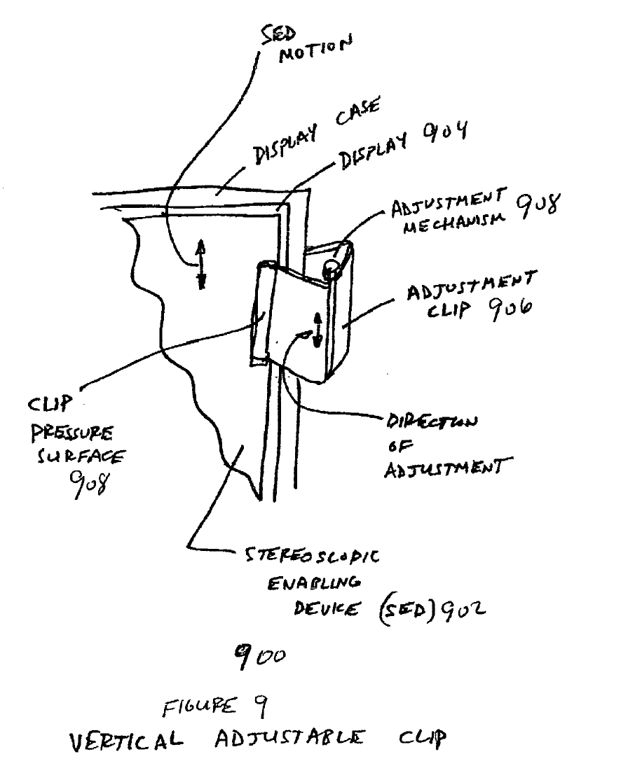

FIG. 8 illustrates the lenticular SED 800. The lenticular SED consists of an array of long, narrow lenses. The image from the display consists of alternating stripes of left-eye and right-eye image information. Each lens focuses on the image information behind the lens and directs the light in different directions. At an appropriate position, the viewer will see the right view of the image through the slits with the right eye and the left view with the left eyes.

Vertical Adjustable Clip

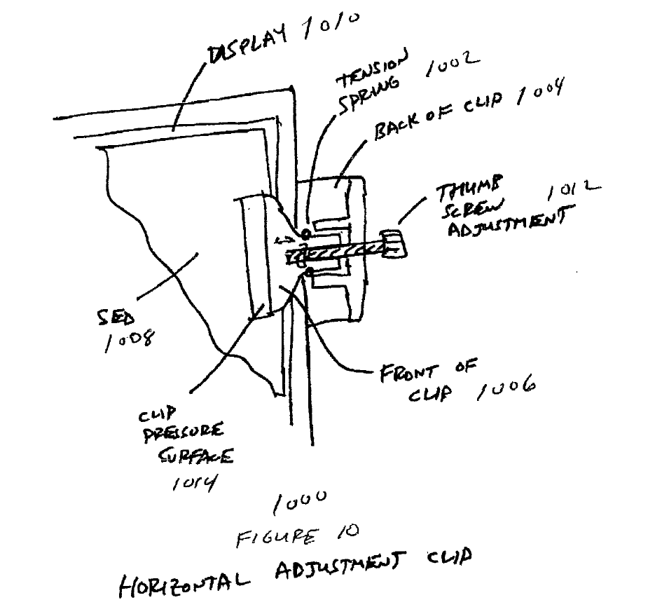

FIG. 9 illustrates an integration of the adjustment mechanism with the clipping mechanism in the form of an adjustable clip 900. The figure shows the upper right hand corner of a display system. The SED 902 is set against the display 504 and held in place with the adjustment clip 906. The clip pressure surface 908 presses against the SED 902 to hold it against the display 904. The user can adjust the adjustment mechanism 908 to move the SED 902 vertically on the display and achieve the final alignment between the SED 902 and the display 904. The adjustment mechanism can be implemented using rotational thread systems, miniature worm gears, rack and pinion systems, sliding wedge systems, and rotational cams for example. Other mechanical systems can be used to replace the adjustment mechanism as would be known by someone skilled in the art.

It is also possible to place the vertical adjustment clip 906 on other portions of the display, like the left side or the lower right side for example. More than one adjustment clip may be used. For example, one clip could be on the left and one clip could be on the right.

FIG. 9 illustrates a vertical adjustment that is needed by μPol and other horizontal type SEDs. It is possible to mount the same clip on the top or bottom of the display to achieve a horizontal adjustment for parallax barrier and lenticular SEDs.

Horizontal Adjustable Clip

FIG. 10 illustrates a horizontal adjustment clip 1000. A tension spring 1002 holds the back of clip 1004 and front of clip 1006 pieces together and provides the force to hold the SED 1008 to the display 1010. The thumbscrew adjustment 1012 allows the user to adjust the horizontal position of the front of clip 1006 that moves the SED 1008 horizontally on the display 1010 through the actions of the clip pressure surface 1014. It is possible to replace the thumbscrew adjustment 1012 with other mechanical systems like rotational cams, sliding wedges, and other systems known to someone skilled in the art of mechanisms. It is possible to position the horizontal adjustment clip 1000 in other positions on the display. It is possible to use more than one horizontal adjustment clip 1000 to hold and adjust the SED 1008. It is also possible to place the horizontal adjustment clip 1000 on the top or bottom of the display 1010 to allow for vertical movement of the SED 1008.

While the invention has been described with reference to preferred embodiments, it will be understood by those skilled in the art that various changes may be made and equivalents may be substituted for elements thereof without departing from the scope of the invention. In addition many modifications may be made to adapt a particular situation or material to the teachings of this invention without departing from the essential scope thereof. Therefore it is intended that the invention not be limited to the particular embodiments disclosed as the best mode contemplated for this invention, but that the invention will include all embodiments falling with the scope of the appended claims.

What is claimed is:

1. An apparatus for easy attachment and alignment of a 3D stereoscopic enabling device comprising:
a stereoscopic enabling device; and
a mounting mechanism, wherein said stereoscopic enabling device is mounted over the viewing area of a viewing device.

2. The apparatus of claim 1, wherein said stereoscopic enabling device comprises a micropolarizer.

3. The apparatus of claim 1, wherein said stereoscopic enabling device comprises a parallel barrier device.

4. The apparatus of claim 1, wherein said stereoscopic enabling device comprises a lenticular device.

5. The apparatus of claim 1, wherein said mounting mechanism comprises a spring clip.

6. The apparatus of claim 5, wherein said spring clip further comprises removable handles.

7. The apparatus of claim 5, wherein said mounting mechanism comprises a thumb screw pressure adjustment.

8. The apparatus of claim 1, wherein said mounting mechanism further comprises removable adjustable grips.

9. The apparatus of claim 1, wherein said mounting mechanism comprises a screw clip device.

10. The screw clip device of claim 9 comprises:
a first surface applying pressure upon a stereoscopic enabling device mounted upon the display area of said display device;
a second surface coupled to a thumb screw;
a ball joint coupled to a first end of said thumb screw, wherein said ball joint applies pressure on a second side of said display side via a rubber foot and further wherein said thumb screw has a thumb adjustment on a second end of said thumb screw wherein said thumb screw adjustment applies a variable force upon the stereoscopic enabling device.

11. A method of attaching and aligning a 3D stereoscopic enabling device to a display device comprising:
placing a stereoscopic enabling device over the viewing area of said display device;
attaching a mounting mechanism to said stereoscopic enabling device and to said display device;
adjusting said mounting mechanism to provide sufficient pressure on stereoscopic enabling device to hold it in place yet let a position adjustment be made;
attaching one or more alignment grips;
displaying an alignment image on said display device; and
aligning said stereoscopic enabling device.

12. The method of claim 11 further comprising removing said alignment grips.

13. The method of claim 11 further comprising further adjusting said mounting mechanism to provide sufficient pressure on said stereoscopic enabling device to prevent any movement in the position of said stereoscopic enabling device relative to it proper alignment position.

14. The method of claim 11 wherein said stereoscopic enabling device comprises a micropolarizer.

15. The method of claim 11 wherein said stereoscopic enabling device comprises a parallel barrier device.

16. The method of claim 11 wherein said stereoscopic enabled device comprises a lenticular device.

17. The method of claim 11 wherein said mounting mechanism comprises a spring clip apparatus.

18. The method of claim 17 wherein said spring clip apparatus includes removable handles.

19. The method of claim 17 wherein said spring clip apparatus includes a thumb screw pressure adjustment.

20. The method of claim 11 wherein said mounting mechanism comprises a screw clip apparatus.
